(19) United States
(12) Patent Application Publication
(10) Pub. No.: US 2026/0166423 A1
(43) Pub. Date: Jun. 18, 2026

(54) GAME CHARACTER CONTROL FOR ASYMMETRIC GAMEPLAY

(71) Applicant: NETEASE (HANGZHOU) NETWORK CO., LTD., Hangzhou (CN)

(72) Inventor: Yichen HAN, Hangzhou (CN)

(21) Appl. No.: 19/129,264

(22) PCT Filed: Apr. 4, 2023
(86) PCT No.: PCT/CN2023/086205

§ 371 Date: May 12, 2025

(30) Foreign Application Priority Data
Nov. 11, 2022 (CN) 202211413942.3

(51) Int. Cl. A63F 13/52; A63F 13/58

(52) U.S. Cl. CPC A63F 13/52; A63F 13/58

(57) ABSTRACT

The present disclosure provides a game character control method. The method includes: in response to an attack instruction, controlling a game character to perform an attack operation on a target virtual object in a game scene; in response to the attack operation and the target virtual object satisfying a preset interaction condition, determining a current additional impact parameter possessed by the game character and corresponding to the target virtual object; and based on the current additional impact parameter and a basic impact parameter of the attack operation, updating a preset attribute value of the target virtual object.

### CROSS REFERENCE TO RELATED APPLICATIONS

The present disclosure is a 371 national phase application of PCT Application No. PCT/CN 2023/086205 filed Apr. 4, 2023, which claims priority to the Chinese Patent Application No. 202211413942.3, entitled “GAME CHARACTER CONTROL METHOD AND APPARATUS, AND ELECTRONIC DEVICE” filed with the China National Intellectual Property Administration on Nov. 11, 2022, the entire content of which applications are incorporated into the present disclosure by reference.

### TECHNICAL FIELD

The present disclosure relates to the technical field of computer applications, and in particular to a method, system, and apparatus for controlling a game character in asymmetric gameplay.

### BACKGROUND

Asymmetric games generally refer to games where the opposing sides are unbalanced. For example, a 1v4 gameplay mode, in which one player is against four players, is a typical asymmetric game characterized by an unequal confrontation between two fractions. During gameplay, each side follows its own game rules, and the game rules followed by the two sides are different.

Generally, the fraction with more players have fewer skills. For instance, they may only be able to run or may lack weapons to fight enemies, and must achieve victory only through cooperation and escape. In contrast, the fraction with fewer players not only runs faster than other players but can also eliminate all other players using various means such as weapons to secure the final victory. This results in the abilities of the side with fewer players being fully exposed to the opposing side and deprives them of the fun of stealth or concealment, thereby reducing game enjoyment.

### SUMMARY

The present disclosure provides a method, system, and apparatus for controlling a game character in asymmetric gameplay.

According to a first aspect, the present disclosure provides a game character control method, including: in response to an attack instruction, controlling a game character to perform an attack operation on a target virtual object in a game scene, where the game scene is displayed through a graphical user interface and comprises at least one game character, and the target virtual object comprises a virtual object from a different faction than the game character; in response to the attack operation and the target virtual object satisfying a preset interaction condition, determining a current additional impact parameter possessed by the game character and corresponding to the target virtual object, where the current additional impact parameter is configured for the game character in response to the game character performing a target interaction operation on the target virtual object; and updating, based on the current additional impact parameter and a basic impact parameter of the attack operation, a preset attribute value of the target virtual object.

According to a second aspect, the present disclosure provides a system including one or more memory collectively containing one or more programs, and one or more processors, where the one or more processors are configured to, individually or collectively, perform the operations of one or more steps of the above-described method for controlling a game character.

According to a third aspect, the present disclosure provides one or more non-transitory computer-readable storage media containing, in any combination, computer program code that, when executed by a computer system, perform operations of one or more steps of the above-described method for controlling a game character.

In order to make the above objective, features and advantages of the present disclosure more apparent and understandable, preferred embodiments will be provided below in detail with reference to the accompanying drawings.

### BRIEF DESCRIPTION OF THE DRAWINGS

In order to more clearly illustrate the technical solutions in the specific implementations of the present disclosure and the related art, the accompanying drawings used in the description of the specific implementations and the related art will be briefly described below, and it is obvious that the accompanying drawings in the description below only represent some embodiments of the present disclosure, and for a person skilled in the art, other drawings can further be obtained from these drawings without the exercise of inventive effort.

FIG. 1 is a flowchart of a game character control method provided by one of the embodiments of the present disclosure.

FIG. 2 is a schematic diagram of a game scene provided by one of the embodiments of the present disclosure.

FIG. 3 is a schematic structural diagram of a game character control apparatus provided by one of the embodiments of the present disclosure.

FIG. 4 is a schematic structural diagram of another game character control apparatus provided by one of the embodiments of the present disclosure.

FIG. 5 is a schematic structural diagram of an electronic device provided by one of the embodiments of the present disclosure.

### DETAILED DESCRIPTION

In order to make the objective, technical solutions, and advantages of the embodiments of the present disclosure clearer, the technical solutions of the present disclosure will be clearly and completely described below with reference to the accompanying drawings. Obviously, the described embodiments are only some, not all, of the embodiments of the present disclosure. All other embodiments obtained by persons skilled in the art based on the embodiments of the present disclosure without the exercise of inventive effort shall fall within the scope of protection of the present disclosure.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, to perform a particular function.

Asymmetric games are games in which players can choose different characters and factions or teams, thus resulting in the players'strengths being limited or enhanced. For example, the asymmetric games may be 1V5, 1V4, 2V6, and 2V5 games where opposing sides are unbalanced. Currently, in asymmetric games, the faction with fewer players typically can eliminate all other players using various means such as weapons to secure the final victory. This results in the abilities of the faction with fewer players being fully exposed to the opposing side and deprives them of the fun of stealth or concealment, thereby reducing game enjoyment.

Accordingly, the embodiments of the present disclosure provide a game character control method and apparatus and an electronic device, which can effectively alleviate the above problems to enhance game enjoyment and attract more players while reducing the processing burden on the terminal device and save terminal device power.

For ease of understanding the present embodiment, first, a game character control method disclosed in the embodiment of the present disclosure is described in detail.

In one embodiment, the present disclosure provide a game character control method, and in one of the embodiments of the present disclosure, the game character control method may be run on a local terminal device or a server. When the game character control method runs on a server, the method can be implemented and performed on the basis of a cloud interaction system, where the cloud interaction system includes a server and a client device.

In one embodiment, various cloud applications may run under the cloud interaction system, for example: cloud gaming. Using cloud gaming as an example, cloud gaming refers to a gaming mode based on cloud computing. In the cloud gaming operation mode, the entity executing the game program and the entity presenting the game screen are separate. Storage and execution of the game character control method are completed on a cloud game server, while the function of a client device is to receive and send data and present the game screen. For example, the client device may be a display device having a data transmission function close to the player side, such as a mobile terminal, a television, a computer, or a handheld computer, but information processing is performed by the cloud game server in the cloud. During play, the player operates the client device to send an operation instruction to the cloud game server, and the cloud game server runs the game according to the operation instruction, encodes and compresses data such as a game screen, and returns the data to the client device via a network, and finally the game screen is decoded and displayed by means of the client device.

In one embodiment, using a game as an example, a local terminal device stores a game program and is used to present a game screen. The local terminal device is used to interact with the player via a graphical user interface, i.e., conventionally download and install and run the game program via an electronic device. The local terminal device may provide the graphical user interface to the player in a variety of ways, for example, the graphical user interface may be rendered on the display screen of the terminal, or may be provided to the player by means of holographic projection. For example, the local terminal device may include a display screen and a processor, the display screen being used for presenting the graphical user interface including a game screen, and the processor being used for running the game, generating the graphical user interface, and controlling the display of the graphical user interface on the display screen.

In one embodiment, the present disclosure provides a game character control method in which a graphical user interface is provided by means of a terminal device, wherein the terminal device may be the local terminal device mentioned above, and may also be the client device in the cloud interaction system mentioned above.

The embodiments of the present disclosure bring the following beneficial effects: the present disclosure provides a method, system, and apparatus for controlling a game character, including: in response to an attack instruction, a game character can be controlled to perform an attack operation on a target virtual object in a game scene; in response to the attack operation and the target virtual object satisfying a preset interaction condition, a current additional impact parameter possessed by the game character and corresponding to the target virtual object can be determined; and based on the current additional impact parameter and a basic impact parameter of the attack operation, a preset attribute value of the target virtual object can be updated. The current additional impact parameter is typically a parameter configured for the game character in response to the game character performing a target interaction operation on the target virtual object. During configuration of the current additional impact parameter, different current additional impact parameters can be configured according to different attack operations, so that the game character can correspondingly obtain different current additional impact parameters when responding to the attack instruction. The disclosed embodiments improve the flexibility of the player in controlling the game character, thereby further improving game enjoyment and experience while reducing the processing burden on the terminal device and saving terminal device power.

Other features and advantages of the present disclosure will be set forth in the following description, and will become apparent partly from the description, or can be learned by the implementation of the present disclosure. The objective and other advantages of the present disclosure are realized and obtained by the structures particularly pointed out in the description, claims and drawings.

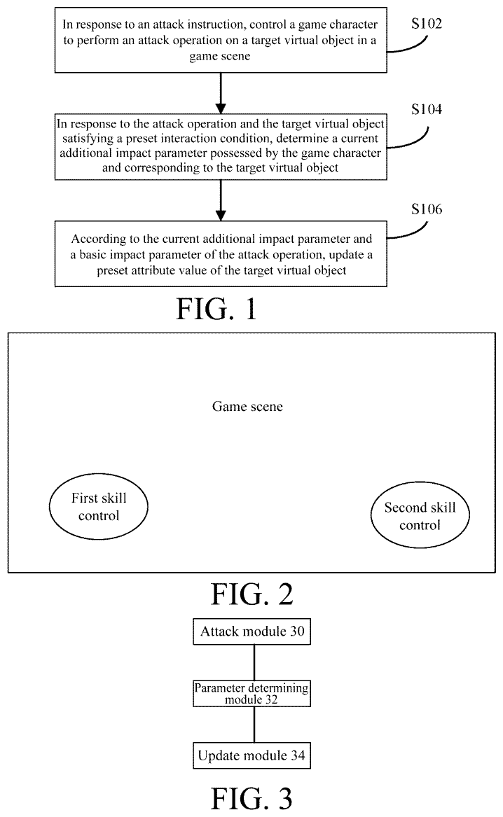

Further, in the game character control method provided by the embodiment of the present disclosure, a game scene is displayed through a graphical user interface, and the game scene includes at least one game character. Specifically, as shown in the flowchart of a game character control method shown in FIG. 1, the method includes the following steps.

Step S102: in response to an attack instruction, the game character is controlled to perform an attack operation on a target virtual object in the game scene; where the target virtual object in the embodiment of the present disclosure is a virtual object from a different faction than the game character; and further, the game character in the embodiment of the present disclosure generally refers to a game character in an asymmetric game, and further refers to a game character in the faction with fewer players in an asymmetric game. Hence, when the player selects said game character, the game character may respond to the attack instruction and perform the attack operation.

Step S104: in response to the attack operation and the target virtual object satisfying a preset interaction condition, a current additional impact parameter possessed by the game character and corresponding to the target virtual object is determined; where the current additional impact parameter is a parameter configured for the game character in response to the game character performing a target interaction operation on the target virtual object; and further, satisfying the preset interaction condition typically means that the target virtual object has been successfully attacked, so that after the target virtual object has been successfully attacked, the game character can possess the current additional impact parameter corresponding to the target virtual object.

Step S106: according to the current additional impact parameter and a basic impact parameter of the attack operation, a preset attribute value of the target virtual object is updated.

In actual use, the current additional impact parameter typically refers to a parsing value for the target virtual object obtained after the game character has successfully attacked the target virtual object, and after the game character obtains the corresponding parsing value, the target virtual object generally loses a corresponding health value.

Further, the basic impact parameter of the attack operation typically refers to the lethality inflicted on the target virtual object after the game character uses a corresponding skill of the attack operation, and therefore, both the current additional impact parameter and the basic impact parameter of the attack operation can impact the health value of the target virtual object, weakening the health value of the target virtual object; and the preset attribute value typically refers to a corresponding parameter used to characterize the health value of the target virtual object, such as a health bar or a health point.

According to the game character control method provided by the embodiment of the present disclosure, in response to an attack instruction, a game character can be controlled to perform an attack operation on a target virtual object in a game scene; in response to the attack operation and the target virtual object satisfying a preset interaction condition, a current additional impact parameter possessed by the game character and corresponding to the target virtual object can be determined; and according to the current additional impact parameter and a basic impact parameter of the attack operation, a preset attribute value of the target virtual object can be updated, where the current additional impact parameter is typically a parameter configured for the game character in response to the game character performing a target interaction operation on the target virtual object, and during configuration of the current additional impact parameter, different current additional impact parameters can be configured according to different attack operations, so that the game character can correspondingly obtain different current additional impact parameters when responding to an attack instruction, which improves the flexibility of the player in controlling the game character, thereby improving game enjoyment and experience while reducing the processing burden on the terminal device and saving terminal device power.

In actual use, an additional impact parameter list is typically maintained for each game character in a backend server of the game, and the additional impact parameter list stores at least one additional impact parameter of a virtual object from a different faction than the game character.

Therefore, during determination of the current additional impact parameter possessed by the game character and corresponding to the target virtual object, the pre-stored additional impact parameter list may be obtained, so that the current additional impact parameter corresponding to the target virtual object can be easily extracted from the additional impact parameter list.

Further, to update the preset attribute value during gameplay, a corresponding data table is typically maintained for each game character in the backend server of the game. In this table, corresponding data and parameters can be updated at any time for different target virtual objects. For example, when the game character targets a target virtual object A, in response to the attack operation and the target virtual object satisfying a preset interaction condition, the game character possess a current additional impact parameter corresponding to the target virtual object A, and at this time, the current additional impact parameter is recorded in a data table corresponding to the target virtual object A, and a basic impact parameter of the current attack operation is obtained; and a preset attribute value of the target virtual object A is updated in the data table by using the current additional impact parameter and the basic impact parameter of the attack operation. Similarly, when the game character targets a target virtual object B, there is also a corresponding data table, and for each attack operation, involved parameters and preset attribute values can all be recorded and updated in the backend server of the game.

Specifically, the current additional impact parameter in the embodiment of the present disclosure is typically a parameter accumulated according to at least one historical attack operation performed on the target virtual object by the game character and satisfying the preset interaction condition.

Further, to facilitate determination of the current additional impact parameter when the attack operation and the target virtual object satisfy the preset interaction condition, a preset update parameter corresponding to the current additional impact parameter is typically pre-configured in the backend server of the game, and the preset update parameter may also be stored in the aforementioned data table in advance, so that when the attack operation and the target virtual object satisfy the preset interaction condition, as a response, the current additional impact parameter can be determined according to the preset update parameter.

Specifically, the current additional impact parameter may be generally equal to the preset update parameter, or may be a multiple of the preset update parameter calculated according to a certain ratio, which may be specifically set according to actual use conditions, and is not limited in the embodiments of the present disclosure.

Generally, when the game character is in different states, the current additional impact parameters determined in response to the attack operation and the target virtual object satisfying the preset interaction condition are different. For example, the game character, either in a stealth state or a non-stealth state, may still perform an attack operation on the target virtual object in the game scene, and the game character in different states may release different skills, so that the determined current additional impact parameters are also different.

Further, in some states of the game character, in response to the attack operation and the target virtual object satisfying the preset interaction condition, the current additional impact parameter may be determined according to the preset update parameter, and in some states of the game character, in response to the attack operation and the target virtual object satisfying the preset interaction condition, it is possible to only update the preset attribute value of the target virtual object while keeping the current additional impact parameter.

Hence, in the embodiments of the present disclosure, when the current additional impact parameter is determined according to the preset update parameter, it is typically necessary to first determine the state of the game character.

Specifically, in the embodiments of the present disclosure, when the current additional impact parameter is determined according to the preset update parameter in response to the attack operation and the target virtual object satisfying the preset interaction condition, it is possible to determine, in response to the attack operation and the target virtual object satisfying the preset interaction condition, that the game character is in a first target state, and determine the current additional impact parameter according to the preset update parameter.

The first target state is a state in which the current additional impact parameter changes in response to the attack operation and the target virtual object satisfying the preset interaction condition, and therefore, the current additional impact parameter may be determined according to the preset update parameter.

Further, in the embodiments of the present disclosure, in addition to the first target state, a second target state may further be set, and in the second target state, in response to the attack operation and the target virtual object satisfying the preset interaction condition, it is possible to only update the preset attribute value of the target virtual object while keeping the current additional impact parameter unchanged.

Hence, the embodiments of the present disclosure further include the following method: in response to the attack operation and the target virtual object satisfying the preset interaction condition, determining that the game character is in a second target state, updating the preset attribute value of the target virtual object according to the current additional impact parameter and the basic impact parameter of the attack operation, and maintaining the current additional impact parameter.

Further, for the first target state, during actual control of the game character, a first state corresponding to the first target state may be set. Specifically, in response to the attack operation and the target virtual object satisfying the preset interaction condition, it is possible to determine that the game character is in the first state, and then determine the current additional impact parameter according to the first preset update parameter, and at this time, the current additional impact parameter determined according to the first preset update parameter is the current additional impact parameter for the game character when in the first state during gameplay.

Further, for the second target state, the actual state of the game character during gameplay, such as a second state, may also be set.

Further, in the first state, different sub-states may be correspondingly set for the game character, such as a first sub-state corresponding to the first state, and further, in the second state, a sub-state may also be set, such as a second sub-state corresponding to the second state. Moreover, the first state and the second state may be switched by the player, and switching may also be allowed between the first state and the first sub-state of the first state, as well as between the second state and the second sub-state of the second state.

In order to facilitate switching control of the state of the game character by the user, the game scene typically further includes skill controls corresponding to the game character; the skill controls include a first skill control and a second skill control; and the player may control the game character and execute state switching through the first skill control and the second skill control. For example, if the default state of the game character is the first state, the game character is in the first state after the game starts, then the game character may release skills in the first state by controlling the first skill control; and the second skill control typically corresponds to a first sub-state of the first state, so that the game character may switch between the first state and the first sub-state of the first state by touching the second skill control.

Furthermore, the first state, the second state, the first sub-state of the first state, and the second sub-state of the second state of the game character may all be switched by means of the first skill control and the second skill control, and therefore, the method in the embodiment of the present disclosure further includes the following switching process: when the game character is in the first state, in response to a state switching operation acting on the second skill control, the game character may be controlled to enter the first sub-state of the first state from the first state. In some embodiments, such as when the game character is in the first state, in response to a state switching operation acting on the first skill control, the game character is controlled to enter the second state from the first state. In some embodiments, such as when the game character is in the second state, in response to a state switching operation acting on the second skill control, the game character is controlled to enter the second sub-state of the second state from the second state.

Further, if the player needs to control the game character to enter the second state for battle, then the state switching operation may be executed through the first skill control to switch the game character from the first state to the second state, and at this time, in the second state, by means of controlling the first skill control, the game character may be enabled to release skills in the second state, and the second skill control typically corresponds to the second sub-state of the second state, so that the game character may be switched between the second state and the second sub-state of the second state by touching the second skill control.

In order to enable the player to experience more flexible and diverse game experience, the current additional impact parameters in different states are typically different, and the skills released by the game character in different states are also different. In this way, the player would be more interested in controlling the game character, and can select suitable states and skills when in different scenes or when going against virtual objects from different factions, so as to control the game character to battle.

Specifically, in the embodiments of the present disclosure, the step of in response to the attack operation and the target virtual object satisfying the preset interaction condition, determining that the game character is in the first state further includes the following: in response to the attack operation and the target virtual object satisfying the preset interaction condition, determining that the game character is in the first sub-state of the first state, updating the preset attribute value of the target virtual object according to the current additional impact parameter and the basic impact parameter of the attack operation, and maintaining the current additional impact parameter (i.e., only the preset attribute value of the target virtual object is updated without adding the current additional impression parameter); and further, in response to the attack operation and the target virtual object satisfying the preset interaction condition, it may be determined that the game character is in the second state, the preset attribute value of the target virtual object is updated according to the current additional impact parameter and the basic impact parameter of the attack operation, and the current additional impact parameter is maintained.

In addition, in response to the attack operation and the target virtual object satisfying the preset interaction condition, it is determined that the game character is in the second sub-state of the second state, the preset attribute value of the target virtual object is updated according to the current additional impact parameter and the basic impact parameter of the attack operation, and the current additional impact parameter is maintained.

In the embodiments of the present disclosure, the second target state is a state in which, in response to the attack operation and the target virtual object satisfying the preset interaction condition, only the preset attribute value of the target virtual object is updated and the current additional impact parameter remains unchanged; as a result, the first sub-state of the first state, the second state, and the second sub-state of the second state are actually all states included in the second target state.

Further, since the game character may correspondingly have different skills in different states, after it is determined that the game character is in a different state, the basic impact parameter of the attack operation is different, and consequently, the update to the preset attribute value of the target virtual object is also different. Moreover, in each state, the release of the skill by the game character may further impact the next attack operation. For example, in the second sub-state of the second state, if a melee attack succeeds, then after the next melee attack is initiated and is successfully executed, the determined current additional influence parameter may be increased according to a certain ratio.

For example, in the first state, if the current additional impact parameter is determined to be 10, the corresponding game character may have a parsing value of +10; and if a melee attack succeeds in the second sub-state of the second state, then in the next melee attack in the first state, the determined current additional impact parameter may be configured to 20, so that the game character in different states may obtain different parsing values of the target virtual object.

In addition, the game character may also be configured with a special skill state, such as the second state in the embodiments of the present disclosure. In the second state, when the attack operation and the target virtual object satisfy the preset interaction condition, and more specifically, the target virtual object has been successfully attacked, the preset attribute value of the target virtual object may be updated only according to the current additional impact parameter and the basic impact parameter of the attack operation, and the current additional impact parameter is maintained. Typically, this state refers to a state in which the game character may release a special skill, for example, a skill that delivers a fatal blow to the target virtual object or exposes the position of the target virtual object, or the like. At this time, in order to ensure the fairness of the game, the current additional impact parameter of the game character may be maintained.

For example, when performing an attack operation on the target virtual object in the game scene in the second state, the game character may remain invisible throughout the process or a precise exposure area visible to all attackers on the target virtual object may be added, so that the game character can easily engage in a melee attack. Further, the second sub-state of the second state typically refers to a state in which a special skill is released, such as accelerating attacks or delivering a fatal blow to the target virtual object. In this case, parsing values cannot be accumulated.

Generally, the second state and the second sub-state of the second state are mainly states in which the game character engages in a melee attack with the target virtual object. In this state, the game character may release a skill that delivers a fatal blow to the target virtual object but parsing values cannot be accumulated; and upon successful execution, the game character is forcibly switched back to the first state (i.e., the default state).

Hence, in the embodiments of the present disclosure, in response to the attack operation and the target virtual object satisfying the preset interaction condition, after it is determined that the game character is in the second state, the preset attribute value of the target virtual object is updated according to the current additional impact parameter and the basic impact parameter of the attack operation, and the current additional impact parameter is maintained. Subsequently, the game character may further be switched to the first state in response to completion of updating the preset attribute value of the target virtual object.

Further, the second sub-state of the second state typically also refers to a melee attack state, except that in this melee attack state, the game character may be switched from the second sub-state of the second state to the first state in response to termination of the attack instruction; and a skill cooldown for the second sub-state of the second state is set for the game character, and the current additional impact parameter is determined according to a second preset update parameter.

For example, in the second sub-state of the second state, after the game character initiates a melee attack, regardless of whether the target virtual object is hit, the game character is switched from the second sub-state of the second state to the first state (i.e., the default state) to prevent the game character from continuously being in the special skill state. At the same time, a skill cooldown for the second sub-state of the second state is further set for the game character, so that the game character enters a post-cast delay state, thereby preventing continuous execution of the melee attack by the game character. At this time, the current additional image parameter is determined according to the second preset update parameter, so that the game character, when being switched back to the first state and executing an attack again, can continue to respond to the attack operation and the target virtual object satisfying the preset interaction condition, and at this time, it is determined that the current additional impact parameter possessed by the game character and corresponding to the target virtual object is the current additional image parameter determined according to the second preset update parameter.

Generally, since the game character in the previous state executes an attack on the target virtual object by using a special skill such as a melee attack, when the game character executes a normal attack again after being switched back to the first state, the lethality against the target virtual object increases due to the recent melee attack. Therefore, the current additional image parameter determined according to the second preset update parameter is typically greater than the current additional impact parameter determined according to the first preset update parameter.

For example, if the current additional impact parameter determined according to the first preset update parameter has a parsing value of +10, then the current additional image parameter determined according to the second preset update parameter may have a parsing value of +20 to ensure fairness and rationality in the game.

In actual use, the first state and the second state are two states in an active attack mode corresponding to the first skill control. The first state is a default state, which is a default active attack state, and the second state is typically set as an active attack state with a higher combat value or attack value (i.e., combat capability of a higher tier). For example, the second state is set as a stealth state; specifically, during gameplay, the player can control the game character to enter stealth mode to achieve a higher level of active attack, and at this time, when the game character is controlled to enter the second state corresponding to the first skill control, it is necessary to control the game character to enter a presentation mode corresponding to the stealth state. The presentation mode is typically preset, and game resources corresponding to the presentation mode of the stealth state can be designed in a game design stage, and these game resources are pulled for rendering when the game character is controlled to enter the second state corresponding to the first skill control, so as to display the presentation mode corresponding to the stealth state.

Furthermore, given that the combat value or attack value of the game character is elevated in the stealth state, to ensure fairness and rationality in the game, the field of view of the game character in the stealth state is limited. However, since the game character belongs to the faction with fewer players or the pursuing faction, when the field of view is limited, an exposed area of a hostile character (i.e., a precise area on the target virtual object within the displayed field of view) may be added to expose the target virtual object, so that the game character can easily engage in a melee attack; for example, the player may trigger the first skill control to cause the game character to release the skill in the second state, so as to engage in an melee attack with the exposed character. Furthermore, in this state, after the corresponding skill is released, a specific cooling time is typically required before the next skill is released.

Further, for the second skill control, the player may also control the game character to execute an active attack. Specifically, the game character is controlled to release the corresponding skill in response to a skill release operation for the second skill control. Furthermore, different states correspond to different skills, and therefore, different renderings may be executed in the field of view of the game character for different states.

In actual use, to facilitate control of the game character by the player, the first skill control and the second skill control may be typically directly disposed on two sides of the graphical user interface, thereby facilitating control by the player, and avoiding blocking the game scene. For ease of understanding, FIG. 2 shows a schematic diagram of a game scene, and the first skill control and the second skill control are shown in FIG. 2.

The player may directly perform triggering through the first skill control and the second skill control to allow the game character to enter the corresponding state. Meanwhile, for each skill control, a state switching operation may also be performed to switch between the states corresponding to the skill controls, so as to enrich the skill of the game character, increase the game effect of the game character, and improve the enjoyment of the player.

It should be understood that the aforementioned trigger operations, skill release operations and state switching operations for the skill controls may be selected and set by the player, or may be set by the game designer in the game design stage (e.g., set as long-press, single-click, double-click, etc.). Specific implementations may vary based on actual usage conditions, and are not limited in the embodiments of the present disclosure.

Further, based on the above embodiments, the embodiments of the present disclosure further provide a game character control apparatus. A game scene is displayed through a graphical user interface, and the game scene includes at least one game character. Specifically, as shown in the schematic structural diagram of a game character control apparatus in FIG. 3, the apparatus includes: an attack module 30, configured to control, in response to an attack instruction, the game character to perform an attack operation on a target virtual object in a game scene, where the target virtual object is a virtual object from a different faction than the game character; a parameter determining module 32, configured to determine, in response to the attack operation and the target virtual object satisfying a preset interaction condition, a current additional impact parameter possessed by the game character and corresponding to the target virtual object, where the current additional impact parameter is a parameter configured for the game character in response to the game character performing a target interaction operation on the target virtual object; and an update module 34, configured to update a preset attribute value of the target virtual object according to the current additional impact parameter and a basic impact parameter of the attack operation.

Further, the parameter determining module 32 is further configured to: in response to the attack operation and the target virtual object satisfying the preset interaction condition, determine the current additional impact parameter according to a preset update parameter.

Further, the current additional impact parameter is a parameter accumulated according to at least one historical attack operation performed on the target virtual object by the game character and satisfying the preset interaction condition.

Further, the step of determining the current additional impact parameter according to a preset update parameter in response to the attack operation and the target virtual object satisfying the preset interaction condition is: in response to the attack operation and the target virtual object satisfying the preset interaction condition, determining that the game character is in a first state, and determining the current additional impact parameter according to a preset update parameter.

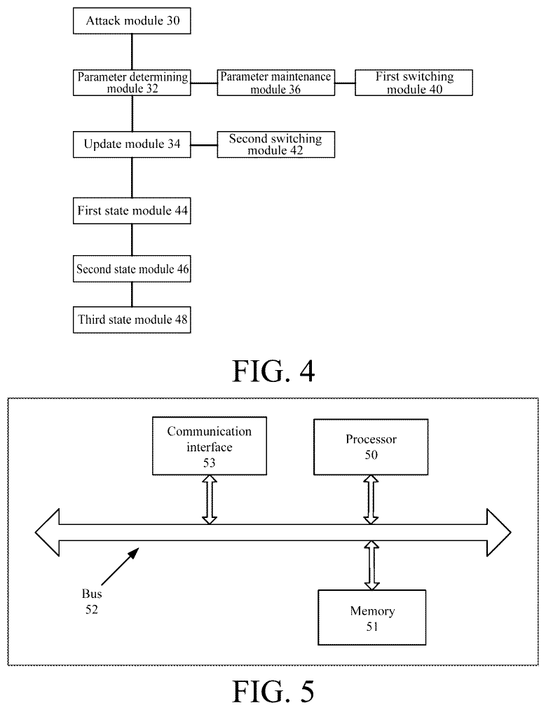

Further, based on FIG. 3, FIG. 4 further shows a schematic structural diagram of another game character control apparatus. As shown in FIG. 4, in addition to the structure shown in FIG. 3, the apparatus further includes: a parameter maintenance module 36, configured to: in response to the attack operation and the target virtual object satisfying the preset interaction condition, determine that the game character is in a first sub-state of a first state, update the preset attribute value of the target virtual object according to the current additional impact parameter and the basic impact parameter of the attack operation, and maintain the current additional impact parameter; and in response to the attack operation and the target virtual object satisfying the preset interaction condition, determine that the game character is in a second state, update the preset attribute value of the target virtual object according to the current additional impact parameter and the basic impact parameter of the attack operation, and maintain the current additional impact parameter and in response to the attack operation and the target virtual object satisfying the preset interaction condition, determine that the game character is in a second state, update the preset attribute value of the target virtual object according to the current additional impact parameter and the basic impact parameter of the attack operation, and maintain the current additional impact parameter; a first switching module 40, configured to: in response to completion of updating the preset attribute value of the target virtual object, switch the game character to the first state; and a second switching module 42, configured to: in response to termination of an attack instruction, switch the game character from the second sub-state of the second state to the first state; and set a skill cooldown for the second sub-state of the second state for the game character.

Further, the parameter determining module 32 is further configured to: obtain a pre-stored additional impact parameter list, wherein the additional impact parameter list stores at least one additional impact parameter of a virtual object from a different faction than the game character; and extract the current additional impact parameter corresponding to the target virtual object from the additional impact parameter list.

Further, the game scene further includes skill controls corresponding to the game character; the skill controls include a first skill control and a second skill control. The apparatus further includes: a first state module 44, configured to: when the game character is in the first state, in response to a state switching operation acting on the second skill control, control the game character to enter the first sub-state of the first state from the first state; a second state module 46, configured to: when the game character is in the first state, in response to a state switching operation acting on the first skill control, control the game character to enter the second state from the first state; and a third state module 48, configured to: when the game character is in the second state, in response to a state switching operation acting on the second skill control, control the game character to enter the second sub-state of the second state from the second state.

In this way, during configuration of the current additional impact parameter, different current additional impact parameters can be configured according to different attack operations, so that the game character can correspondingly obtain different current additional impact parameters when responding to the attack instruction, which improves the flexibility of the player in controlling the game character, thereby improving game enjoyment and experience while reducing the processing burden on the terminal device and saving terminal device power.

The game character control apparatus provided by the embodiment of the present disclosure has the same technical features as the game character control method provided by the above embodiment, and therefore can also solve the same technical problems and achieve the same technical effects.

FIG. 5 shows a schematic structural diagram of an electronic device provided by an embodiment of the present disclosure. The electronic device includes: a processor 50, a memory 51, a bus 52, and a communication interface 53, where the processor 50, the communication interface 53, and the memory 51 are connected via the bus 52. The memory stores machine-readable instructions executable by the processor, and when the electronic device executes a game character control method as described in the embodiments, the processor communicates with the memory via the bus, and the processor executes the machine-readable instructions to perform the following steps: in response to an attack instruction, controlling the game character to perform an attack operation on a target virtual object in the game scene, where the target virtual object is a virtual object from a different faction than the game character; in response to the attack operation and the target virtual object satisfying a preset interaction condition, determining a current additional impact parameter possessed by the game character and corresponding to the target virtual object, where the current additional impact parameter is a parameter configured for the game character in response to the game character performing a target interaction operation on the target virtual object; and according to the current additional impact parameter and a basic impact parameter of the attack operation, updating a preset attribute value of the target virtual object.

In some embodiments, the processor 701 is further configured to, in response to the attack operation and the target virtual object satisfying the preset interaction condition, determine the current additional impact parameter according to a preset update parameter.

In some embodiments, the current additional impact parameter is a parameter accumulated according to at least one historical attack operation performed on the target virtual object by the game character and satisfying the preset interaction condition.

In some embodiments, when determining the current additional impact parameter according to a preset update parameter in response to the attack operation and the target virtual object satisfying the preset interaction condition, the processor 701 is specifically configured to, in response to the attack operation and the target virtual object satisfying the preset interaction condition, determine that the game character is in a first target state, and determine the current additional impact parameter according to the preset update parameter.

In some embodiments, when determining, in response to the attack operation and the target virtual object satisfying the preset interaction condition, that the game character is in the first target state, and determining the current additional impact parameter according to the preset update parameter, the processor 701 is specifically configured to, in response to the attack operation and the target virtual object satisfying the preset interaction condition, determine that the game character is in a first state, and determine the current additional impact parameter according to a first preset update parameter.

In some embodiments, the processor 701 is further configured to, in response to the attack operation and the target virtual object satisfying the preset interaction condition, determine that the game character is in a second target state, update the preset attribute value of the target virtual object according to the current additional impact parameter and the basic impact parameter of the attack operation, and maintain the current additional impact parameter.

In some embodiments, the processor 701 is further configured to, in response to the attack operation and the target virtual object satisfying the preset interaction condition, determine that the game character is in a first sub-state of the first state, update the preset attribute value of the target virtual object according to the current additional impact parameter and the basic impact parameter of the attack operation, and maintain the current additional impact parameter.

In some embodiments, the processor 701 is further configured to, in response to the attack operation and the target virtual object satisfying the preset interaction condition, determine that the game character is in a second state, update the preset attribute value of the target virtual object according to the current additional impact parameter and the basic impact parameter of the attack operation, and maintain the current additional impact parameter.

In some embodiments, the processor 701 is further configured to, in response to the attack operation and the target virtual object satisfying the preset interaction condition, determine that the game character is in a second state, update the preset attribute value of the target virtual object according to the current additional impact parameter and the basic impact parameter of the attack operation, and maintain the current additional impact parameter.

In some embodiments, the processor 701 is further configured to, in response to completion of updating the preset attribute value of the target virtual object, switch the game character to the first state.

In some embodiments, the processor 701 is further configured to: in response to termination of the attack instruction, switch the game character from the second sub-state of the second state to the first state; and set a skill cooldown for the second sub-state of the second state for the game character, and determine the current additional impact parameter according to a second preset update parameter.

In some embodiments, when determining the current additional impact parameter possessed by the game character and corresponding to the target virtual object, the processor 701 is specifically configured to: obtain a pre-stored additional impact parameter list, wherein the additional impact parameter list stores at least one additional impact parameter of a virtual object from a different faction than the game character; and extract the current additional impact parameter corresponding to the target virtual object from the additional impact parameter list.

In some embodiments, the game scene further includes skill controls corresponding to the game character; the skill controls include a first skill control and a second skill control; and the processor 701 is further configured to: when the game character is in the first state, in response to a state switching operation acting on the second skill control, control the game character to enter a first sub-state of the first state from the first state.

In some embodiments, the processor 701 is further configured to, when the game character is in the first state, in response to a state switching operation acting on the first skill control, control the game character to enter the second state from the first state.

In some embodiments, the processor 701 is further configured to, when the game character is in the second state, in response to a state switching operation acting on the second skill control, control the game character to enter the second sub-state of the second state from the second state.

In this way, during configuration of the current additional impact parameter, different current additional impact parameters can be configured according to different attack operations, so that the game character can correspondingly obtain different current additional impact parameters when responding to the attack instruction, which improves the flexibility of the player in controlling the game character, thereby improving game enjoyment and experience while reducing the processing burden on the terminal device and saving terminal device power.

In practical applications, the memory 51 may include a high-speed random access memory (RAM), or may further include a non-volatile memory, such as at least one magnetic disk memory. a communication connection between the system network element and at least one other network element is implemented via the at least one communication interface 53 (which may be wired or wireless), and the Internet, a wide area network, a local area network, a metropolitan area network, or the like may be used. The bus 52 may be an ISA (Industrial Standard Architecture) bus, a PCI (Peripheral Component Interconnect) bus, an EISA (Enhanced Industry Standard Architecture) bus, or the like. The bus may be classified into an address bus, a data bus, a control bus, etc. For ease of representation, only one double-headed arrow is used to represent the bus in FIG. 5, but this does not mean that there is only one bus or only one type of bus.

The processor 50 may be an integrated circuit chip with signal processing capability. In an implementation process, the steps in the foregoing methods may be implemented via a hardware integrated logic circuit in the processor 50, or instructions in a form of software. The processor 50 may be a general-purpose processor including a central processing unit (Central Processing Unit, CPU for short), a network processor (Network Processor, NP for short), or the like; The processor may also be a digital signal processor (DSP for short), an application-specific integrated circuit (ASIC for short), a field-programmable gate array (FPGA for short) or another programmable logic device, a discrete gate or transistor logic device, or a discrete hardware component. The processor may implement or execute the methods, steps and logical block diagrams disclosed in the embodiments of the present disclosure. The general-purpose processor may be a microprocessor, or the processor may be any conventional processor or the like. The steps of the method disclosed in combination with the embodiments of the present disclosure may be directly executed and completed by a hardware decoding processor, or may be executed and completed by a combination of hardware and software modules in the decoding processor. The software modules may be located in a mature storage medium in the art, such as a random access memory, a flash memory, a read-only memory, a programmable read-only memory, an electrically erasable programmable memory, or a register. The storage medium is located in the memory 51, and the processor 50 reads information in the memory 51 and completes the steps of the method in the foregoing embodiments in combination with hardware of the processor 50.

An embodiment of the present disclosure further provides a computer-readable storage medium storing a computer program that, when run by the processor, enables the processor to perform the following steps: in response to an attack instruction, controlling the game character to perform an attack operation on a target virtual object in the game scene, where the target virtual object is a virtual object from a different faction than the game character; in response to the attack operation and the target virtual object satisfying a preset interaction condition, determining a current additional impact parameter possessed by the game character and corresponding to the target virtual object, where the current additional impact parameter is a parameter configured for the game character in response to the game character performing a target interaction operation on the target virtual object; and according to the current additional impact parameter and a basic impact parameter of the attack operation, updating a preset attribute value of the target virtual object.

In some embodiments, the processor is further configured to, in response to the attack operation and the target virtual object satisfying the preset interaction condition, determine the current additional impact parameter according to a preset update parameter.

In some embodiments, the current additional impact parameter is a parameter accumulated according to at least one historical attack operation performed on the target virtual object by the game character and satisfying the preset interaction condition.

In some embodiments, when determining the current additional impact parameter according to a preset update parameter in response to the attack operation and the target virtual object satisfying the preset interaction condition, the processor is specifically configured to, in response to the attack operation and the target virtual object satisfying the preset interaction condition, determine that the game character is in a first target state, and determine the current additional impact parameter according to the preset update parameter.

In some embodiments, when determining, in response to the attack operation and the target virtual object satisfying the preset interaction condition, that the game character is in the first target state, and determining the current additional impact parameter according to the preset update parameter, the processor is specifically configured to, in response to the attack operation and the target virtual object satisfying the preset interaction condition, determine that the game character is in a first state, and determine the current additional impact parameter according to a first preset update parameter.

In some embodiments, the processor is further configured to, in response to the attack operation and the target virtual object satisfying the preset interaction condition, determine that the game character is in a second target state, update the preset attribute value of the target virtual object according to the current additional impact parameter and the basic impact parameter of the attack operation, and maintain the current additional impact parameter.

In some embodiments, the processor is further configured to, in response to the attack operation and the target virtual object satisfying the preset interaction condition, determine that the game character is in a first sub-state of the first state, update the preset attribute value of the target virtual object according to the current additional impact parameter and the basic impact parameter of the attack operation, and maintain the current additional impact parameter.

In some embodiments, the processor is further configured to, in response to the attack operation and the target virtual object satisfying the preset interaction condition, determine that the game character is in a second state, update the preset attribute value of the target virtual object according to the current additional impact parameter and the basic impact parameter of the attack operation, and maintain the current additional impact parameter.

In some embodiments, the processor is further configured to, in response to the attack operation and the target virtual object satisfying the preset interaction condition, determine that the game character is in a second state, update the preset attribute value of the target virtual object according to the current additional impact parameter and the basic impact parameter of the attack operation, and maintain the current additional impact parameter.

In some embodiments, the processor is further configured to, in response to completion of updating the preset attribute value of the target virtual object, switch the game character to the first state.

In some embodiments, the processor is further configured to: in response to termination of the attack instruction, switch the game character from the second sub-state of the second state to the first state; and set a skill cooldown for the second sub-state of the second state for the game character, and determine the current additional impact parameter according to a second preset update parameter.

In some embodiments, when determining the current additional impact parameter possessed by the game character and corresponding to the target virtual object, the processor is specifically configured to: obtain a pre-stored additional impact parameter list, wherein the additional impact parameter list stores at least one additional impact parameter of a virtual object from a different faction than the game character; and extract the current additional impact parameter corresponding to the target virtual object from the additional impact parameter list.

In some embodiments, the game scene further includes skill controls corresponding to the game character; the skill controls include a first skill control and a second skill control; and the processor is further configured to, when the game character is in the first state, in response to a state switching operation acting on the second skill control, control the game character to enter a first sub-state of the first state from the first state.

In some embodiments, the processor is further configured to, when the game character is in the first state, in response to a state switching operation acting on the first skill control, control the game character to enter the second state from the first state.

In some embodiments, the processor is further configured to, when the game character is in the second state, in response to a state switching operation acting on the second skill control, control the game character to enter the second sub-state of the second state from the second state.

In this way, during configuration of the current additional impact parameter, different current additional impact parameters can be configured according to different attack operations, so that the game character can correspondingly obtain different current additional impact parameters when responding to the attack instruction, which improves the flexibility of the player in controlling the game character, thereby improving game enjoyment and experience while reducing the processing burden on the terminal device and saving terminal device power.

A computer program product for the game character control method, the game character control apparatus and the electronic device provided by the embodiments of the present disclosure includes a computer-readable storage medium storing program codes, and instructions included in the program codes may be used to perform the method described in the foregoing method embodiments. For specific implementation, reference may be made to the method embodiments, which will not be repeated herein.

It may be clearly understood by those skilled in the art that, for convenience and brevity of description, for specific working processes of the apparatus described above, reference may be made to corresponding processes in the foregoing method embodiments, which will not be repeated herein.

In addition, in the description of the embodiments of the present disclosure, unless otherwise specified and defined, the terms “install” , “link”, and “connect” should be interpreted broadly, for example, a connection may be a fixed connection, a detachable connection, or an integrated connection; a mechanical connection or electrical connection; and a direct connection, an indirect connection via an intermediary, or an internal communication between two components. For those skilled in the art, the specific meanings of the aforementioned terms in the present disclosure may be understood according to specific circumstances.

The functions, if implemented in the form of software functional units and sold or used as an independent product, may be stored in a computer-readable storage medium. Based on such understanding, the technical solution of the present disclosure essentially, or a part contributing to the related art, or a part of the technical solution may be embodied in the form of a software product, and the computer software product is stored in a storage medium, and includes several instructions to enable a computer device (which may be a personal computer, a server, or a network device, etc.) to perform all or some of the steps of the methods described in the embodiments of the present disclosure. The aforementioned storage medium includes: any type of medium capable of storing a program code, such as a U disk, a mobile hard disk drive, a read-only memory (ROM), a random access memory (RAM), a magnetic disk, or an optical disk.

In the description of the present disclosure, it should be noted that the orientation or position relationships indicated by the terms “center”, “upper”, “lower”, “left”, “right”, “vertical”, “horizontal”, “inner”, “outer”, etc. are based on the orientation or position relationship shown in the drawings. The terms are used solely for the convenience of describing the present disclosure and simplifying the description, rather than indicating or implying that the apparatus or component referred to must have a specific orientation, be constructed and operated in a specific orientation, and thus cannot be understood as a limitation to the present disclosure. In addition, the terms “first”, “second”, and “third” are used for descriptive purposes only and should not be interpreted as indicating or implying relative importance.

Finally, it should be noted that: the above embodiments are merely specific implementations of the present disclosure to illustrate the technical solutions of the present disclosure, rather than to limit the same, and the scope of protection of the present disclosure is not limited thereto. Although the present disclosure has been described in detail with reference to the foregoing embodiments, those skilled in the art should understand that: any person skilled in the art can still make modifications or readily conceive variations to the technical solutions described in the foregoing embodiments, or make equivalent replacements to some of the technical features within the technical scope disclosed in the present disclosure. Such modifications, variations, or replacements shall not cause the essence of the corresponding technical solutions to depart from the spirit and scope of the technical solutions of the embodiments of the present disclosure, and shall fall within the scope of protection of the present disclosure. Therefore, the protection scope of the present disclosure should be based on the scope of protection of the Claims.

1. A game character control method,
comprising:
in response to an attack instruction, controlling a game character to perform an attack operation on a target virtual object in a game scene, wherein the game scene is displayed through a graphical user interface and comprises at least one game character, and the target virtual object comprises a virtual object from a different faction than the game character;
in response to the attack operation and the target virtual object satisfying a preset interaction condition, determining a current additional impact parameter possessed by the game character and corresponding to the target virtual object, wherein the current additional impact parameter is configured for the game character in response to the game character performing a target interaction operation on the target virtual object; and
updating, based on the current additional impact parameter and a basic impact parameter of the attack operation, a preset attribute value of the target virtual object.

2. The method according to claim 1, further comprising:
in response to the attack operation and the target virtual object satisfying the preset interaction condition, determining the current additional impact parameter based on a preset update parameter.

3. The method according to claim 1, wherein the current additional impact parameter comprises a parameter accumulated based on at least one historical attack operation performed by the game character on the target virtual object and satisfying the preset interaction condition.

4. The method according to claim 2, wherein, in response to the attack operation and the target virtual object satisfying the preset interaction condition, determining the current additional impact parameter based on the preset update parameter comprises:
in response to the attack operation and the target virtual object satisfying the preset interaction condition, determining that the game character is in a first target state, and determining the current additional impact parameter based on the preset update parameter.

5. The method according to claim 4, wherein, in response to the attack operation and the target virtual object satisfying the preset interaction condition, determining that the game character is in the first target state, and determining the current additional impact parameter based on the preset update parameter comprise:
in response to the attack operation and the target virtual object satisfying the preset interaction condition, determining that the game character is in a first state, and determining the current additional impact parameter based on a first preset update parameter.

6. The method according to claim 5, further comprising:
in response to the attack operation and the target virtual object satisfying the preset interaction condition:
determining that the game character is in a second target state,
updating the preset attribute value of the target virtual object based on the current additional impact parameter and the basic impact parameter of the attack operation, and
maintaining the current additional impact parameter.

7. The method according to claim 6, further comprising:
in response to the attack operation and the target virtual object satisfying the preset interaction condition:
determining that the game character is in a first sub-state of the first state,
updating the preset attribute value of the target virtual object based on the current additional impact parameter and the basic impact parameter of the attack operation, and
maintaining the current additional impact parameter.

8. The method according to claim 6, further comprising:
in response to the attack operation and the target virtual object satisfying the preset interaction condition:
determining that the game character is in a second state,
updating the preset attribute value of the target virtual object based on the current additional impact parameter and the basic impact parameter of the attack operation, and
maintaining the current additional impact parameter.

9. The method according to claim 8, further comprising:
in response to the attack operation and the target virtual object satisfying the preset interaction condition:
determining that the game character is in a second sub-state of the second state,
updating the preset attribute value of the target virtual object based on the current additional impact parameter and the basic impact parameter of the attack operation, and
maintaining the current additional impact parameter.

10. The method according to claim 8, further comprising:
in response to completion of updating the preset attribute value of the target virtual object, switching the game character to the first state.

11. The method according to claim 8, further comprising:
in response to termination of the attack instruction, switching the game character from a second sub-state of the second state to the first state; and
setting a skill cooldown for the second sub-state of the second state for the game character, and determining the current additional impact parameter based on a second preset update parameter.

12. The method according to claim 1, wherein determining the current additional impact parameter possessed by the game character and corresponding to the target virtual object comprises:
obtaining a pre-stored additional impact parameter list, wherein the additional impact parameter list stores at least one additional impact parameter of a virtual object from a different faction than the game character; and
extracting the current additional impact parameter corresponding to the target virtual object from the additional impact parameter list.

13. The method according to claim 9, wherein the game scene further comprises one or more skill controls corresponding to the game character, the one or more skill controls comprise a first skill control and a second skill control, and the method further comprises:
in response to the game character being in the first state, and a state switching operation acting on the second skill control, controlling the game character to transition from the first state to a first sub-state of the first state.

14. The method according to claim 13, further comprising:
in response to the game character is being in the first state, and a state switching operation acting on the first skill control, controlling the game character to transition from the first state to the second state

15. The method according to claim 13, further comprising:
in response to the game character being in the second state, and a state switching operation acting on the second skill control, controlling the game character to transition from the second state to the second sub-state of the second state.

16. (canceled)

17. A system, comprising:
one or more memories collectively containing one or more programs; and
one or more processors, wherein the one or more processors are configured to, individually or collectively, perform an operation comprising:
in response to an attack instruction, controlling a game character to perform an attack operation on a target virtual object in a game scene, wherein the game scene is displayed through a graphical user interface and comprises at least one game character, and the target virtual object comprises a virtual object from a different faction than the game character;
in response to the attack operation and the target virtual object satisfying a preset interaction condition, determining a current additional impact parameter possessed by the game character and corresponding to the target virtual object, wherein the current additional impact parameter is configured for the game character in response to the game character performing a target interaction operation on the target virtual object; and
updating, based on the current additional impact parameter and a basic impact parameter of the attack operation, a preset attribute value of the target virtual object.

18. One or more non-transitory computer-readable storage media containing, in any combination, computer program code that, when executable by a computer system, perform an operation comprising:
in response to an attack instruction, controlling a game character to perform an attack operation on a target virtual object in a game scene, wherein the game scene is displayed through a graphical user interface and comprises at least one game character, and the target virtual object comprises a virtual object from a different faction than the game character;
in response to the attack operation and the target virtual object satisfying a preset interaction condition, determining a current additional impact parameter possessed by the game character and corresponding to the target virtual object, wherein the current additional impact parameter is configured for the game character in response to the game character performing a target interaction operation on the target virtual object; and
updating, based on the current additional impact parameter and a basic impact parameter of the attack operation, a preset attribute value of the target virtual object.

19. The system according to claim 17, wherein the operation further comprises:
in response to the attack operation and the target virtual object satisfying the preset interaction condition, determining the current additional impact parameter based on a preset update parameter.

20. The system according to claim 19, wherein, in response to the attack operation and the target virtual object satisfying the preset interaction condition, determining the current additional impact parameter based on the preset update parameter comprises:
in response to the attack operation and the target virtual object satisfying the preset interaction condition, determining that the game character is in a first target state, and determining the current additional impact parameter based on the preset update parameter.

21. The system according to claim 17, wherein determining the current additional impact parameter possessed by the game character and corresponding to the target virtual object comprises:
obtaining a pre-stored additional impact parameter list, wherein the additional impact parameter list stores at least one additional impact parameter of a virtual object from a different faction than the game character; and
extracting the current additional impact parameter corresponding to the target virtual object from the additional impact parameter list.
